(19) United States
(12) Patent Application Publication
(10) Pub. No.: US 2026/0112539 A1
(43) Pub. Date: Apr. 23, 2026

(54) ON-LOAD TAP-CHANGER, METHOD FOR ACTUATING AN ON-LOAD TAP-CHANGER, AND TAP-CHANGING TRANSFORMER HAVING AN ON-LOAD TAP-CHANGER

(71) Applicant: Maschinenfabrik Reinhausen GmbH, Regensburg (DE)

(72) Inventors: Sebastian REHKOPF, Regensburg (DE); Thomas STROF, Nittendorf (DE); Andreas SACHSENHAUSER, Mallersdorf (DE)

(21) Appl. No.: 19/358,472

(22) Filed: Oct. 15, 2025

(30) Foreign Application Priority Data
Oct. 18, 2024 (EP) 24207368.2

(51) Int. Cl. H01F 29/02

(52) U.S. Cl. CPC H01F 29/02

(57) ABSTRACT

An on-load tap-changer is for uninterrupted switchover between winding taps of a tap-changing transformer. The on-load tap-changer includes: fixed contacts being configured such that each of the fixed contacts is connectable to a winding tap of the tap-changing transformer; a first selector arm which is configured to selectively make contact with each of the fixed contacts; a second selector arm which is configured to selectively make contact with each of the fixed contacts; a load take-off lead; a first main current branch which connects the first selector arm to the load take-off lead via at least a first current-limiting element; a second main current branch which connects the second selector arm to the load take-off lead via at least a second current-limiting element; and a bridging circuit configured to selectively bridge the first current-limiting element and/or the second current-limiting element by at least one switching element.

### CROSS REFERENCE TO RELATED APPLICATIONS

This application claims benefit to European Patent Application No. EP 24207368.2, filed on Oct. 18, 2024, which is hereby incorporated by reference herein.

### FIELD

The present disclosure relates to an on-load tap-changer for uninterrupted switchover between winding taps of a tap-changing transformer, to a method for actuating the on-load tap-changer and to a tap-changing transformer having such an on-load tap-changer.

### BACKGROUND

On-load tap-changers are used for uninterrupted switchover between different winding taps of a tap winding of a tap-changing transformer and thus for voltage regulation. For the switchover, on-load tap-changers usually have two moving selector contacts, which connect the winding taps, and further switching contacts, which are arranged in the current branches of the on-load tap-changer and are used to electrically connect the winding tap, connected by the respective selector contact, to a load take-off lead.

One switching principle for on-load tap-changers is the so-called reactor switching principle. In this case, switchover impedances are provided, which limit the current flowing through the on-load tap-changer during the switchover from a winding tap to an adjacent winding tap.

An on-load tap-changer which is designed according to the reactor switching principle can take up two stationary positions. In the so-called bridging, stationary position, a moving selector contact is electrically connected to a first winding tap and the other moving selector contact is electrically connected to a winding tap of the tap-changing transformer that is adjacent to the first winding tap. In this stationary position, a so-called circulating current flows from the first winding tap through the on-load tap-changer to the adjacent winding tap. In this case, the switchover impedances are required to limit the circulating current and thus avoid a tap short circuit.

In the so-called non-bridging, stationary position, both moving selector contacts are electrically connected to the same winding tap of the tap-changing transformer. Here, too, the circulating current flows through the switchover impedances, but no tap short circuit can occur since both selector contacts make contact with the same winding tap. Consequently, the switchover impedances are not required in the non-bridging, stationary position but are still flowed through by current, this generating unnecessary losses.

### SUMMARY

In an embodiment, the present disclosure provides an on-load tap-changer that is for uninterrupted switchover between winding taps of a tap-changing transformer. The on-load tap-changer includes: a plurality of fixed contacts, the fixed contacts being configured such that each of the fixed contacts is connectable to a winding tap of the tap-changing transformer; a first selector arm which is configured to selectively make contact with each of the fixed contacts; a second selector arm which is configured to selectively make contact with each of the fixed contacts; a load take-off lead; a first main current branch which connects the first selector arm to the load take-off lead via at least a first current-limiting element; a second main current branch which connects the second selector arm to the load take-off lead via at least a second current-limiting element; and a bridging circuit configured to selectively bridge the first current-limiting element and/or the second current-limiting element by at least one switching element.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a first embodiment of an on-load tap-changer according to the present disclosure;

FIG. 2 shows a schematic illustration of a second embodiment of the on-load tap-changer according to the present disclosure;

FIG. 3 shows an exemplary sequence of the method according to the present disclosure; and

FIG. 4 shows a further exemplary sequence of the method according to the present disclosure.

### DETAILED DESCRIPTION

Aspects of the present disclosure specify an improved concept for an on-load tap-changer according to the reactor switching principle and the actuation thereof, which concept avoids the losses generated by the switchover impedances and thus reduces the power loss of the entire tap-changing transformer.

According to a first aspect, the present disclosure provides an on-load tap-changer for uninterrupted switchover between winding taps of a tap-changing transformer. The on-load tap-changer comprises a plurality of fixed contacts which are configured in such a way that each fixed contact is able to be connected to a winding tap of the tap-changing transformer. Furthermore, the on-load tap-changer comprises a first selector arm which can selectively make contact with each of the fixed contacts, a second selector arm which can selectively make contact with each of the fixed contacts, a load take-off lead, a first main current branch which connects the first selector arm to the load take-off lead via at least a first current-limiting element, and a second main current branch which connects the second selector arm to the load take-off lead via at least a second current-limiting element.

Moreover, the on-load tap-changer comprises a bridging circuit for selectively bridging the first current-limiting element and/or the second current-limiting element by means of at least one switching element.

The bridging circuit and the at least one switching element are designed to carry the entire load current flowing through the on-load tap-changer at least temporarily, in particular when the on-load tap-changer is in a stationary position.

By means of the bridging circuit, in the stationary position the load current can thus be diverted from the current-limiting elements to the bridging circuit. As a result, only a minimal fraction of the load current still flows through the current-limiting elements, and the losses caused by the current flow through the current-limiting elements can therefore be largely avoided. This is also accompanied by the reduction in the power loss of the tap-changing transformer, this in turn having a positive effect on the service life and the environmental influences of the tap-changing transformer.

According to one embodiment, the at least one switching element is able to be switched in such a way that the first current-limiting element and the second current-limiting element are able to be bridged at the same time.

As a result, loss reduction can additionally be reduced.

According to a further embodiment, the bridging circuit comprises at least three switching elements.

According to one embodiment, the bridging circuit comprises a first switching element, a second switching element and a third switching element, wherein the first switching element and the third switching element are used to bridge the first current-limiting element, and the second switching element and the third switching element are used to bridge the second current-limiting element.

This arrangement of the bridging circuit offers safe, low-loss operation of the on-load tap-changer while the latter is in the non-bridging, stationary position.

According to a further embodiment, the switching elements are configured as mechanical switching contacts which in the closed state carry the load current. The mechanical switching contacts are thus, on account of their material and the structural configuration, for example, the material thickness, designed to carry the current permanently while the on-load tap-changer is in a stationary position.

According to a further embodiment, the bridging circuit has a first switching element, a second switching element, a third switching element and a fourth switching element. The first switching element and the second switching element are each connected in parallel with the first current-limiting element and the third switching element and the fourth switching element are each connected in parallel with the second current-limiting element.

This arrangement of the bridging circuit likewise offers safe, low-loss operation of the on-load tap-changer while the latter is in the non-bridging, stationary position.

According to a further embodiment, the first switching element or the fourth switching element is designed as a vacuum interrupter.

Designing the first switching element and the fourth switching element as vacuum interrupters offers the advantage that contamination of the insulating medium surrounding the on-load tap-changer, for example oil, which would occur in mechanical switchover contacts due to the arcing and the contact wear, is completely eliminated. Moreover, vacuum interrupters have a long service life.

According to a further embodiment, the second switching element or the third switching element is designed as a mechanical switching contact which in the closed state carries the load current.

The mechanical switching contacts are thus, on account of their material and the structural configuration, for example, a sufficiently dimensioned material thickness, designed to carry the current permanently while the on-load tap-changer is in a stationary position.

According to a further embodiment, the first switching element and the fourth switching element are designed as vacuum interrupters.

According to a further embodiment, the second switching element and the third switching element are designed as mechanical switching contacts which in the closed state carry the load current. The mechanical switching contacts are thus, on account of their material and the structural configuration, for example, the material thickness, designed to carry the current permanently while the on-load tap-changer is in a stationary position.

According to a further embodiment, the first current-limiting element and the second current-limiting element are designed as switchover impedances.

The switchover impedance can be designed as an electrical resistor in any desired manner.

According to one preferred embodiment, the switchover impedance comprises a core consisting of iron, and a coil of copper wire wound around the core. In this case, the losses occurring when current flows through the switchover impedance arise predominantly in the coil and less in the core. Thus, it is primarily copper losses which can be reduced by aspects of the present disclosure.

According to a second aspect, the present disclosure provides a method for actuating an on-load tap-changer for uninterrupted switchover between winding taps of a tap-changing transformer. The on-load tap-changer comprises a plurality of fixed contacts, wherein the fixed contacts are configured in such a way that each fixed contact is able to be connected to a winding tap of the tap-changing transformer, a first selector arm which can selectively make contact with each of the fixed contacts, a second selector arm which can selectively make contact with each of the fixed contacts, a load take-off lead, a first main current branch which connects the first selector arm to the load take-off lead via at least a first current-limiting element, a second main current branch which connects the second selector arm to the load take-off lead via at least a second current-limiting element, and a bridging circuit for selectively bridging the first current-limiting element and/or the second current-limiting element by means of at least one switching element. The method has the following method steps:
switching the on-load tap-changer into a stationary position in which the first selector arm and the second selector arm make contact with the same fixed contact and the first current-limiting element and the second current-limiting element are flowed through by current,
closing the at least one switching element of the bridging circuit so that the load current flows via the bridging circuit.

With regard to the method, reference is analogously made to the above explanations, preferred features and/or advantages as have already been explained in relation to the first aspect of the present disclosure or one of the associated, advantageous embodiments.

Closing the at least one switching element means that a large part of the load current is thus switched over from the first main current branch and the second main current branch to the bridging circuit so that almost no more current flows through the current-limiting elements and losses of the current-limiting elements can thus be reduced to a minimum.

According to one embodiment, the bridging circuit of the on-load tap-changer has a first switching element, a second switching element and a third switching element, wherein the method step of closing the at least one switching element of the bridging circuit comprises closing the first switching element, the second switching element and the third switching element.

According to one preferred embodiment, the first switching element, the second switching element and the third switching element become closed at the same time.

According to a further embodiment, the bridging circuit has a first switching element, a second switching element, a third switching element and a fourth switching element, wherein the first switching element and the second switching element are each connected in parallel with the first current-limiting element, and the third switching element and the fourth switching element are each connected in parallel with the second current-limiting element. In this case, the method step of closing the at least one switching element of the bridging circuit comprises closing the first switching element and the fourth switching element, wherein the first switching element and the fourth switching element briefly carry the load current, and comprises closing the second switching element and the third switching element, wherein the second switching element and the third switching element carry the load current while the on-load tap-changer is in the stationary position.

According to one preferred embodiment, first of all the first switching element and the fourth switching element become closed and then in a next method step the second switching element and the third switching element become closed.

According to one preferred embodiment, the first switching element and the fourth switching element are designed as vacuum interrupters which briefly carry the load current during the switchover between two adjacent winding taps of the tap-changing transformer. As a result, no sparking is generated in the insulating medium, for example oil, of the on-load tap-changer by the arc which occurs during the switchover, and contamination in the form of gases in the insulating medium caused by the sparking is reduced.

According to a further preferred embodiment, the second switching element and the third switching elements are designed as mechanical switching elements to conduct the load current permanently while the on-load tap-changer is in the stationary position.

Since part of the commutation of the current has already been carried out by the vacuum interrupters in the previous method step, the commutation work to be performed by the mechanical switching elements is less, and the arcing and the contact wear are accordingly also less pronounced.

According to a third aspect, the present disclosure provides a tap-changing transformer which comprises a tap winding having winding taps, and an on-load tap-changer which can be connected to the tap winding and which is designed according to the first aspect of the present disclosure and is suitable for carrying out a method according to the second aspect of the present disclosure.

With regard to the third aspect, reference is analogously made to the above explanations, preferred features and/or advantages as have already been explained in relation to the first aspect and the second aspect of the present disclosure or one of the associated, advantageous embodiments.

Further embodiments and implementations of the tap-changing transformer arise directly from the various embodiments of the on-load tap-changer and of the method.

Aspects of the present disclosure will be explained in detail below on the basis of exemplary embodiments with reference to the drawings. Components that are identical or functionally identical or have an identical effect may be provided with identical reference signs. Identical components or components with an identical function are in some cases explained only in relation to the figure in which they first appear.

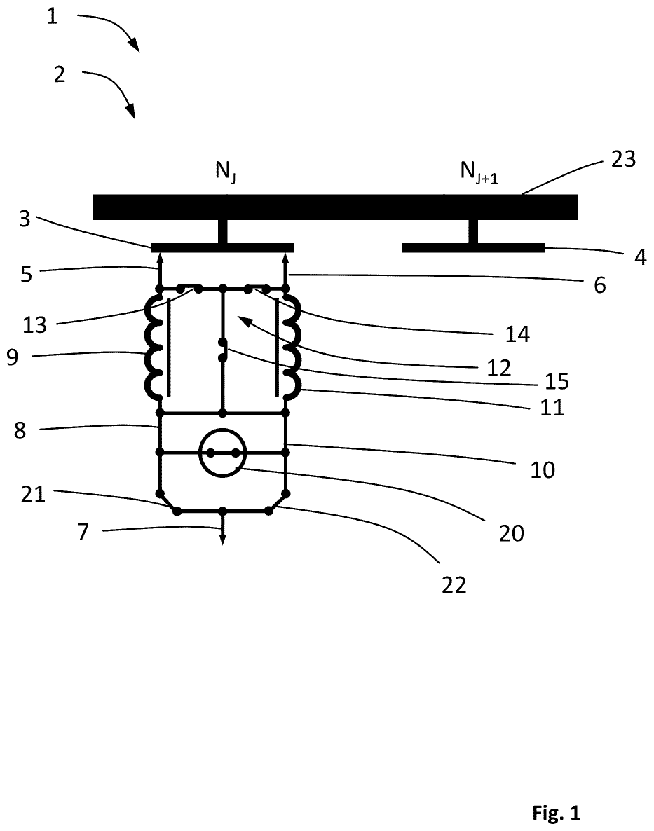

FIG. 1 schematically illustrates a first embodiment of an on-load tap-changer 1 according to the present disclosure. The on-load tap-changer 1 is used for uninterrupted switchover between winding taps N_{J}, N_{J+1}, . . . , N_{N} of a tap winding 23 of a tap-changing transformer 2. The on-load tap-changer 1 comprises at least a first fixed contact 3 and a second fixed contact 4 which can each be connected to a winding tap N_{J}, N_{J+1} of the tap winding 23 of the tap-changing transformer 2. The total number of the fixed contacts 3, 4 is dependent on the total number of the winding taps N_{N}. Each fixed contact 3, 4 has at least one contact surface.

Furthermore, the on-load tap-changer 1 comprises a first selector arm 5 and a second selector arm 6, which can make contact with each of the fixed contacts 3, 4, in particular the contact surfaces of the fixed contacts 3, 4.

In the position illustrated in FIG. 1, the on-load tap-changer 1 is in a non-bridging, stationary position in which the first selector arm 5 and the second selector arm 6 make contact with the same fixed contact 3.

The on-load tap-changer 1 further comprises a first main current branch 8 which connects the first selector arm 5 to a load take-off lead 7 via a first current-limiting element 9, and a second main current branch 10 which connects the second selector arm 6 to the load take-off lead 7 via a second current-limiting element 11. According to this embodiment, the two current-limiting elements 9 and 11 are designed as switchover impedances.

Furthermore, the on-load tap-changer 1 comprises a bridging circuit 12 for selectively bridging the first current-limiting element 9 and the second current-limiting element 11. For bridging the two current-limiting elements 9 and 11, the bridging circuit 12 comprises a total of three switching elements according to this embodiment. A first switching element 13, a second switching element 14 and a third switching element 15. In this case, the first switching element 13 and the third switching element 15 are used to bridge the first current-limiting element 9 and the second switching element 14 and the third switching element 15 are used to bridge the second current-limiting element 11.

According to this embodiment, the three switching elements 13, 14 and 15 are designed, for example, as mechanical switching contacts.

The on-load tap-changer 1 additionally has further switching elements 20, 21 and 22, namely a vacuum interrupter 20, which is connected between the two main current branches 8 and 10, and two bypass contacts 21 and 22, which each make the electrical connection to the load take-off lead 7. Through corresponding actuation of the moving selector arms 5 and 6 and of the switching elements 20, 21 and 22, switchover between the adjacent winding taps N_{J}, N_{J+1} of the tap winding 23 of the tap-changing transformer 2, or the respective fixed contacts 3, 4 of the on-load tap-changer 1, is carried out.

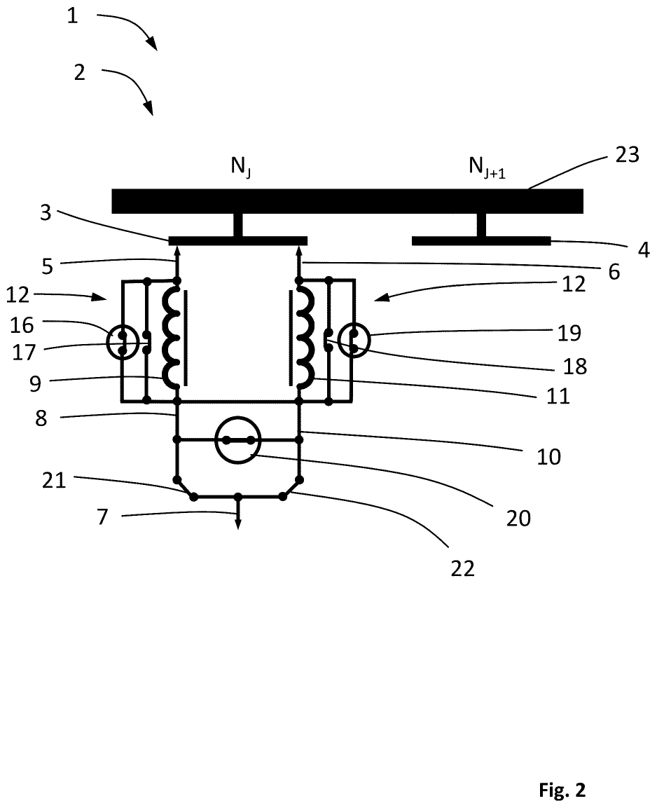

FIG. 2 shows a schematic illustration of a second embodiment of the on-load tap-changer 1 according to the present disclosure. With regard to the on-load tap-changer 1, reference is analogously made to the above explanations relating to the on-load tap-changer 1 from FIG. 1 and only the differences and supplementary features are discussed below.

In the position illustrated in FIG. 2, the on-load tap-changer 1 is likewise in a non-bridging, stationary position in which the first selector arm 5 and the second selector arm 6 make contact with the same fixed contact 3.

According to this embodiment, the on-load tap-changer 1 has a bridging circuit 12 which has a total of four switching elements 16, 17, 18, 19 for bridging the two current-limiting elements 9 and 11. A first switching element 16 and a second switching element 17 are arranged in parallel with each other and in each case in parallel with the first current-limiting element 9 and a third switching element 18 and a fourth switching element 19 are likewise connected in parallel with each other and in each case in parallel with the second current-limiting element 11. According to this embodiment, the first switching element 16 and the fourth switching element 19 are designed, for example, as vacuum interrupters and the second switching element 17 and the third switching element 18 are designed, for example, as mechanical switching contacts. The vacuum interrupters are advantageously designed to briefly carry the load current and thereby prevent sparking in the insulating medium. The mechanical switching contacts are advantageously designed to conduct the load current permanently while the on-load tap-changer 1 is in the stationary position.

FIGS. 1 and 2 illustrate by way of example the respective on-load tap-changer in a single-phase implementation. However, aspects of the present disclosure are also able to be used in a three-phase tap-changer arrangement.

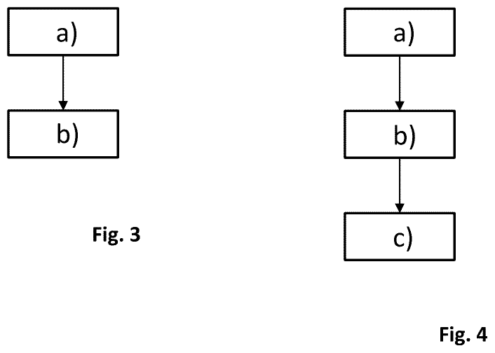

FIG. 3 illustrates an exemplary sequence of the method according to the present disclosure. Advantageously, the method illustrated in FIG. 3 is carried out by means of the on-load tap-changer 1 from FIG. 1. With regard to the on-load tap-changer 1, reference is analogously made to the above explanations relating to the on-load tap-changer from FIG. 1 and only the differences and supplementary features are discussed below.

According to this exemplary embodiment of the method according to the present disclosure, in a step a) the on-load tap-changer 1 is switched into a stationary position in which the first selector arm 5 and the second selector arm 6 make contact with the same fixed contact 3, 4 and the first current-limiting element 9 and the second current-limiting element 11 are flowed through by current.

Then, in a step b), the first switching element 13, the second switching element 14 and the third switching element 15 become closed.

In this switching position, which constitutes the non-bridging stationary position of the on-load tap-changer, the load current is thus diverted from the current-limiting elements to the bridging circuit, namely the first switching element, the second switching element and the third switching element. As a result, only a minimal fraction of the load current still flows through the current-limiting elements, and the losses caused by the current flow through the current-limiting elements can therefore be largely avoided.

FIG. 4 illustrates a further exemplary sequence of the method according to the present disclosure. Advantageously, the method illustrated in FIG. 4 is carried out by means of the on-load tap-changer 1 from FIG. 2. With regard to the on-load tap-changer 1, reference is analogously made to the above explanations relating to the on-load tap-changer 1 as described in connection with FIGS. 1 and 2 and only the differences and supplementary features are discussed below.

According to this exemplary embodiment of the method according to the present disclosure, in a step a), the on-load tap-changer 1 is likewise switched into a stationary position in which the first selector arm 5 and the second selector arm 6 make contact with the same fixed contact 3, 4 and the first current-limiting element 9 and the second current-limiting element 11 are flowed through by current.

Then, in a step b), the first switching element 16 and the fourth switching element 19 become closed and, in a subsequent step c), the second switching element 17 and the third switching element 18 become closed.

In this switching position, in which the on-load tap-changer is likewise in the non-bridging stationary position, the load current is thus diverted from the current-limiting elements to the bridging circuit. In this exemplary implementation of the method, this diversion is thus carried out in two steps b) and c), wherein first of all the current is only briefly taken over by the first and fourth switching element 16, 19 before it is finally commuted to the second switching element 17 and the third switching element 18 which carry the current so long as the on-load tap-changer is in this switching position. As a result, only a minimal fraction of the load current still flows through the current-limiting elements, and the losses caused by the current flow through the current-limiting elements can therefore be largely avoided.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

1 On-load tap-changer
2 Tap-changing transformer
3 Fixed contact
4 Fixed contact
5 First selector arm
6 Second selector arm
7 Load take-off lead
8 First main current branch
9 First current-limiting element
10 Second main current branch
11 Second current-limiting element
12 Bridging circuit
13 First switching element
14 Second switching element
15 Third switching element
16 First switching element
17 Second switching element
18 Third switching element
19 Fourth switching element
20 Vacuum interrupter
21 Bypass contact
22 Bypass contact
23 Tap winding
N_{J}, N_{J+1}, . . . , N_{N} Winding taps of 23

1. An on-load tap-changer for uninterrupted switchover between winding taps of a tap-changing transformer, the on-load tap-changer comprising:
a plurality of fixed contacts, the fixed contacts being configured such that each of the fixed contacts is connectable to a winding tap of the tap-changing transformer;
a first selector arm which is configured to selectively make contact with each of the fixed contacts;
a second selector arm which is configured to selectively make contact with each of the fixed contacts;
a load take-off lead;
a first main current branch which connects the first selector arm to the load take-off lead via at least a first current-limiting element;
a second main current branch which connects the second selector arm to the load take-off lead via at least a second current-limiting element; and
a bridging circuit configured to selectively bridge the first current-limiting element and/or the second current-limiting element by at least one switching element.

2. The on-load-tap-changer according to claim 1, wherein:
the at least one switching element is configured to be switched such that the first current-limiting element and the second current-limiting element are able to be bridged at the same time.

3. The on-load-tap-changer according to claim 1, wherein:
the bridging circuit comprises at least three switching elements, which comprises the at least one switching element.

4. The on-load-tap-changer according to claim 1, wherein:
the at least one switching element of the bridging circuit comprises a first switching element, a second switching element, and a third switching element,
the first switching element and the third switching element are configured to bridge the first current-limiting element, and
the second switching element and the third switching element are configured to bridge the second current-limiting element.

5. The on-load-tap-changer according to claim 3, wherein:
the at least three switching elements are configured as mechanical switching contacts which in a closed state carry the load current.

6. The on-load-tap-changer according to claim 1, wherein:
the at least one switching element of the bridging circuit comprises a first switching element, a second switching element, a third switching element, and a fourth switching element,
the first switching element and the second switching element are each connected in parallel with the first current-limiting element, and
the third switching element and the fourth switching element are each connected in parallel with the second current-limiting element.

7. The on-load-tap-changer according to claim 6, wherein:
the first switching element and/or the fourth switching element are/is designed as a vacuum interrupter, and
the second switching element and/or the third switching element are/is designed as a mechanical switching contact which in the closed state carries the load current.

8. The on-load-tap-changer according to claim 1, wherein:
the first current-limiting element and the second current-limiting element are designed as switchover impedances.

9. A method for actuating an on-load tap-changer for uninterrupted switchover between winding taps of a tap-changing transformer, comprising a plurality of fixed contacts, wherein the fixed contacts are configured such that each of the fixed contacts is connectable to a winding tap of the tap-changing transformer, a first selector arm which is configured to selectively make contact with each of the fixed contacts, a second selector arm which is configured to selectively make contact with each of the fixed contacts, a load take-off lead, a first main current branch which connects the first selector arm to the load take-off lead via at least a first current-limiting element, a second main current branch which connects the second selector arm to the load take-off lead via at least a second current-limiting element, and a bridging circuit configured to selectively bridge the first current-limiting element and/or the second current-limiting element by f at least one switching element, the method comprising:
switching the on-load tap-changer into a stationary position in which the first selector arm and the second selector arm make contact with a same fixed contact of the plurality of fixed contacts and the first current-limiting element and the second current-limiting element are flowed through by current; and
closing the at least one switching element of the bridging circuit so that a load current flows via the bridging circuit.

10. The method according to claim 9, wherein the at least one switching element of the bridging circuit comprises a first switching element, a second switching element and a third switching element, and
wherein the closing of the at least one switching element of the bridging circuit comprises closing the first switching element, the second switching element and the third switching element.

11. The method according to claim 9, wherein the at least one switching element of the bridging circuit comprises a first switching element, a second switching element, a third switching element, and a fourth switching element, the first switching element and the second switching element are each connected in parallel with the first current-limiting element, and the third switching element and the fourth switching element are each connected in parallel with the second current-limiting element,
wherein the closing of the at least one switching element of the bridging circuit comprises closing the first switching element and the fourth switching element, wherein the first switching element and the fourth switching element briefly carry the load current, and
wherein the method further comprises closing the second switching element and the third switching element, wherein the second switching element and the third switching element carry the load current while the on-load tap-changer is in the stationary position.

12. A tap-changing transformer, the tap-changing transformer comprising
a tap winding having winding taps, and
the on-load tap-changer of claim 1 that is configured to be connected to the tap winding.
